(19) United States
(12) Patent Application Publication
(10) Pub. No.: US 2009/0088359 A1
(43) Pub. Date: Apr. 2, 2009

(54) MALE HYGIENE WIPE

(76) Inventor: Dana D. Denton, Lansing, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/200,005

(22) Filed: Aug. 28, 2008

Related U.S. Application Data
(60) Provisional application No. 60/966,521, filed on Oct. 2, 2007.

(51) Int. Cl. C11D 17/00

(52) U.S. Cl. 510/137

(57) ABSTRACT

A rapidly dissolvable wipe for male groin and genital surfaces includes a thick, absorbent sheet comprised of water-dispersible materials that impart flushability. The wipe has length and width dimensions that substantially exceed the width of standard toilet paper on a roll, and a thickness that substantially exceeds the thickness of standard toilet paper, making the wipe better suited for maintaining cleanliness and excellent hygiene of male groin and genital surfaces.

### CROSS-REFERENCE TO RELATED APPLICATION

This application claims priority under 35 U.S.C. §119(e) on U.S. Provisional Application No. 60/966,521 entitled MALE GROIN URINE WIPES, W/ OR W/O FRAGRANCE, filed Aug. 28, 2007 by Dana D. Denton, the entire disclosure of which is incorporated herein by reference.

### FIELD OF THE INVENTION

This invention relates to male hygiene, and more particularly to the provision of a disposable wipe that is specially adapted for wiping surfaces of a male groin and/or genitals.

### BACKGROUND OF THE INVENTION

After urinating, a male will typically shake or otherwise manipulate his penis to remove urine from the urethra and from the tip of the penis to prevent or minimize soiling of clothing and/or to otherwise promote cleanliness and good hygiene. While this practice is common and provides some benefit, it does not completely remove all urine from the surfaces of male genitalia. As a result, some soiling and staining of undergarments is inevitable. Further, the unsatisfactory extent to which shaking or other manipulation removes urine from the genitals can lead to cleanliness, health and odor issues. In addition, shaking or other manipulation to remove urine from male genitalia can result in some urine being splashed on floors, walls and other bathroom surfaces, which can lead to further cleanliness, health and odor issues.

Many gentlemen prefer to wipe after urinating to improve cleanliness and hygiene, and to prevent soiling of undergarments. Typically, toilet paper or tissue paper may be used for this purpose. However, ordinary toilet paper and ordinary tissue paper are inconvenient and/or are not particularly well suited for wiping male groin and genital surfaces. Ordinary toilet paper is dispensed from rolls that are typically mounted adjacent a commode, and usually at or near hand level for a typical person seated on the commode. As such, roll toilet paper is not generally within reach of a urinal, and is difficult to reach when standing or urinating at a commode. Further, the small squares and relatively thin paper of a standard toilet paper roll are not particularly well suited for wiping male groin and genital surfaces. Ordinary facial tissue is better suited for wiping male groin and genital surfaces because it is wider, thicker and more absorbent than roll toilet paper. However, ordinary facial tissue is not readily degradable or water-dispersible and can plug a commode and/or drain plumbing from the commode if it is disposed of in the commode. Other disposal techniques, such as disposal in a waste basket, are generally unacceptable as they do not provide suitable cleanliness and hygiene, and may cause odor problems.

### SUMMARY OF THE INVENTION

The invention provides a solution to one or more of the problems identified above. In particular, in accordance with one aspect of the invention, there is provided a rapidly dissolving wipe configured for wiping male groin and genital surfaces. The wipe includes a thick, absorbent, single-ply or multiple-ply sheet comprised of water-dispersible materials that impart flushability to the wipe. In accordance with other aspects of the invention, the wipe is configured to have dimensions (i.e., width, length and thickness) that are configured for use in wiping male groin and genital surfaces. In this regard, the wipes of this invention have a length and a width greater than the width of a toilet tissue square and a thickness that is greater than the thickness of ordinary toilet tissue, yet is easily dispersible in water.

In accordance with another aspect of the invention, there is provided a method of maintaining male personal cleanliness. The method comprises a step of wiping the groin and/or genital surfaces after urination with a thick, absorbent single-ply or multiple-ply sheet comprised of water-dispersible materials that impart flushability to the wipe.

These and other features, advantages and objects of the present invention will be further understood and appreciated by those skilled in the art by reference to the following specification, claims and appended drawings.

### DETAILED DESCRIPTION OF PREFERRED EMBODIMENTS

The invention concerns a flushable male hygiene urine groin wipe that does not cause plugging or any related plumbing problems. The flushable male wipes of the invention may be provided in a box-dispenser, similar to the box-dispenser used for ordinary facial tissues. Such boxes can be varied in size and number of tissues, much the way box sizes and number of tissues vary with facial tissues. As an alternative, the flushable male hygiene urine groin wipes of the invention may be provided on rolls, much like ordinary toilet tissue paper, but with larger dimensions more suitable for use as a male groin wipe. As with ordinary toilet tissue rolls, the rolled form of the male groin wipes of the invention may be provided with perforations that allow easy separation of the wipes from the roll into individual sheets.

The groin wipes of this invention can be dry or they can be premoistened, preferably with a nonaqueous liquid humectant, such as propylene glycol. Moistened male wipes in accordance with the invention may be stored and dispensed from plastic containers having a closable lid, similar to the container-dispensers used for moist towelettes and the like.

Preferably, the tissue dispensers used for containing and dispensing the flushable male hygiene urine groin wipes of the invention are configured to be mounted or placed within easy reach for a man standing at a commode.

The term “flushable” as used herein means that the wipe is capable of being flushed in a conventional toilet and being introduced into a municipal sewage or residential septic system without causing an obstruction or blockage in the toilet or sewage system. In this regard, the male groin wipes of the invention are comprised of water-dispersible materials.

The term “water-dispersible” as used herein refers to fibers or other materials that may be incorporated into a fibrous web, and which allows the fibrous web to disintegrate or separate into a plurality of incoherent pieces or particles in an aqueous medium, at a sufficiently fast rate to impart flushability to an article (e.g., wipe) made of the water-dispersible material. Water-dispersible fibers and other materials are well-known in the art. For example, water-dispersible fibers that may be used in a flushable wipe are described in U.S. Pat. No. 6,989,193.

In addition to being flushable, the male groin wipes of this invention are of a size and thickness that is suitable and adequate for wiping the groin and genitals. Generally, the width and thickness of ordinary toilet paper is unsuitable. Preferably, the length and width of the male groin wipes of this invention are each greater than six inches, and more preferably greater than eight inches, and even more preferably greater than 10 inches. Additionally, the male groin wipes of this invention are thicker than ordinary toilet paper. The thickness or caliper of the male groin wipes of this invention is at least 0.1 millimeters, and more preferably at least 0.2 millimeters, and even more preferably at least 0.5 millimeters.

The male groin wipes of this invention promote health, cleanliness and good hygiene. In addition, they may be packaged in a masculine format to encourage male cleanliness, health and hygiene.

The wipes of this invention may be provided with various lotions, scents and/or other additives as desired to impart desired aesthetics or functionality.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A rapidly dissolving wipe configured for wiping male groin and genital surfaces, comprising:
a thick, absorbent single-ply or multiple-ply sheet comprised of water-dispersible materials that impart flushability to the wipe.

2. The wipe of claim 1, having a length and width each greater than six inches.

3. The wipe of claim 1, having a thickness greater than 0.1 millimeters.

4. The wipe of claim 2, having a thickness greater than 0.1 millimeters.

5. A method of maintaining male personal cleanliness comprising:
wiping the groin and/or genital surfaces after urination with a thick, absorbent single-ply or multiple-ply sheet comprised of water-dispersible materials that impart flushability to the wipe.

6. The method of claim 5, having a length and width each greater than six inches.

7. The method of claim 5, having a thickness greater than 0.1 millimeters.

8. The method of claim 6, having a thickness greater than 0.1 millimeters.
